(19) United States
(12) Patent Application Publication
(10) Pub. No.: US 2007/0144952 A1
(43) Pub. Date: Jun. 28, 2007

(54) Water purifying system

(76) Inventor: Shih-Ping Lee, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/504,008

(22) Filed: Aug. 15, 2006

(30) Foreign Application Priority Data
Dec. 22, 2005 (TW) 094222414

(51) Int. Cl. B01D 24/38

(52) U.S. Cl. 210/104; 210/459; 210/257.1

(57) ABSTRACT

A water purifying system includes a base having a storage tank removably engaged with a recess defined in an outside of the storage tank. A purifying device is received in the base and a connection hose is connected between the purifying device and the storage tank. A high level device is located in the storage tank and a low level device is connected to an outlet pipe connected between the storage tank and a pumping device which pumps the purified water in the storage tank to a faucet. The storage tank can be conveniently disengaged from the base so as to be cleaned up.

### FIELD OF THE INVENTION

The present invention relates to a water purifying system with a removable water tank and a pump system to conveniently store and obtain purified water.

### BACKGROUND OF THE INVENTION

A conventional water purifying system 80 is shown in FIGS. 6 and 7, and generally includes a plurality of purifying tanks 81 which can be any type of known purifying device such as reverse osmosis system and unpurified water is introduced into the tanks 81 to isolate and remove the particles in the water and the purified water are then collected into a storage tank 82. A pipe is then connected to a faucet 83 from which the purified water can be obtained. The storage tank 82 includes a flexible separation film 821 to define an upper space 822 and a lower space 823. Pressurized air is introduced into the lower space 823 so that when the user operates the valve on the faucet 83, the separation film 821 is deformed and pushes the water in the upper space to force the water in the upper space 822 to flow out from the faucet 83. Nevertheless, the conventional water purifying system occupies a lot of space and the a longer pipe system is needed and which may increase the possibility of contamination of the water.

FIG. 8 shows another conventional water purifying system 90 which includes a plurality of purifying tanks 91 which can be any type of known purifying device such as reverse osmosis system and unpurified water is introduced into the tanks 91 to isolate and remove the particles in the water and the purified water are then collected into a storage tank 92 which is located above the purifying tanks 91. A level checking device 94 is installed to the storage tank 92 an includes a valve 95, a link 97 which has one pivotably connected to the valve 95 and a float 96 which is connected to the other end of the link 97. A faucet 93 is connected to a lower portion of the storage tank 92 so that when operating the faucet 93, the purified water in the storage tank 92 flows out from the faucet 93. Once the float 96 is lower than a pre-set position, the valve 95 sends a signal to activate a motor to pump purified water into the storage tank 92. The motor might be activated frequently and cause damage. If the link 97 is tool long, the float 96 might not able to pivot the link 97 when the water is at low level.

The present invention intends to provide a water purifying system with compact size and the storage tank can be conveniently disengaged and cleaned.

### SUMMARY OF THE INVENTION

The present invention relates to a water purifying system which includes a base with a recess and a storage tank is removably engaged with the recess. An outlet is defined through a wall of the base so that an outlet pipe is connected between the storage tank and the outlet hole and a hose is connected between the outlet hole and a faucet. A purifying device is 2 received in the base and connected to the storage tank by a connection pipe. An outlet pipe is connected between the storage tank and a pumping device which pumps the purified water to the faucet.

The primary object of the present invention is to provide a water purifying system which has a compact base combined with a removable storage tank, and the piping of the system is received in the base.

Another embodiment of the present invention is to provide a water purifying system which has a high level device and a low level device so as to accurately detect the level of the water level in the storage tank.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the water purifying system of the present invention;

FIG. 2 is a side cross sectional view of the water purifying system of the present invention;

FIG. 3 shows that the water purifying system of the present invention is located beneath the counter top of kitchen sink;

FIG. 4 is an exploded view to show the base and the storage tank of the water purifying system of the present invention;

FIG. 5 shows another embodiment of the water purifying system of the present invention;

FIG. 6 shows a conventional water purifying system;

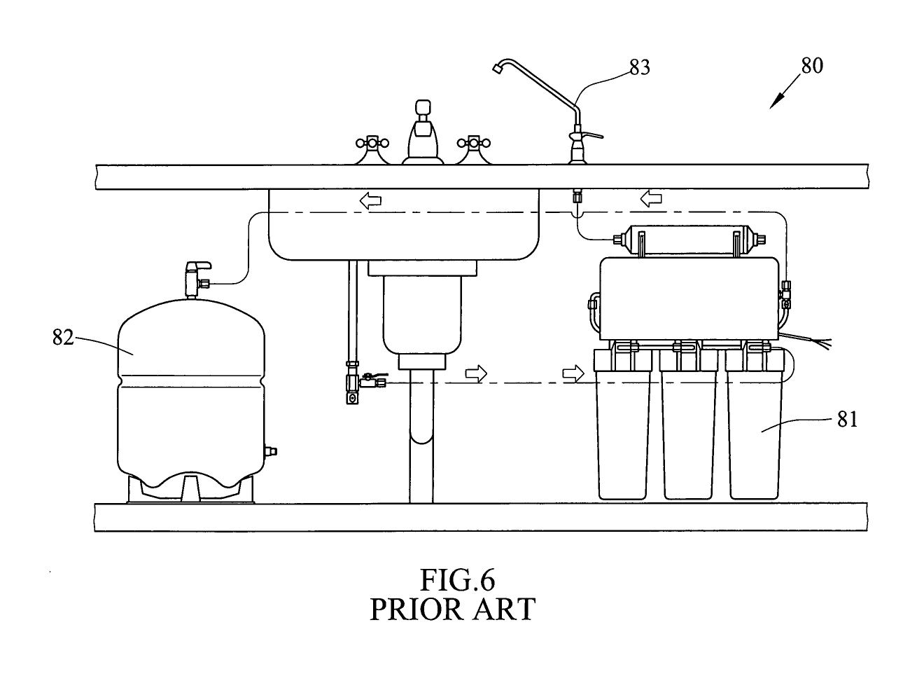

FIG. 7 shows the storage tank of the conventional water purifying system in FIG. 6, and

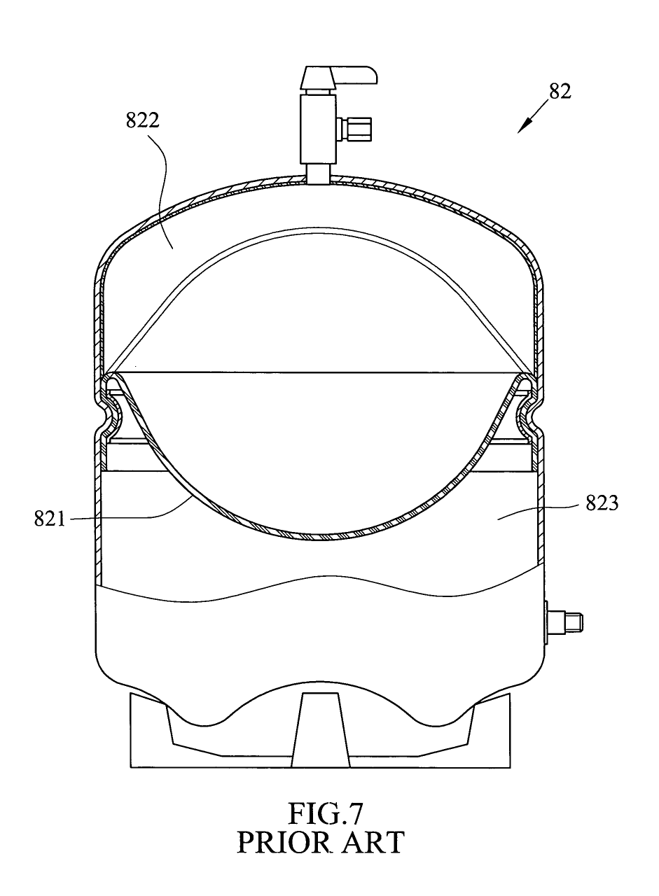

FIG. 8 shows another conventional water purifying system.

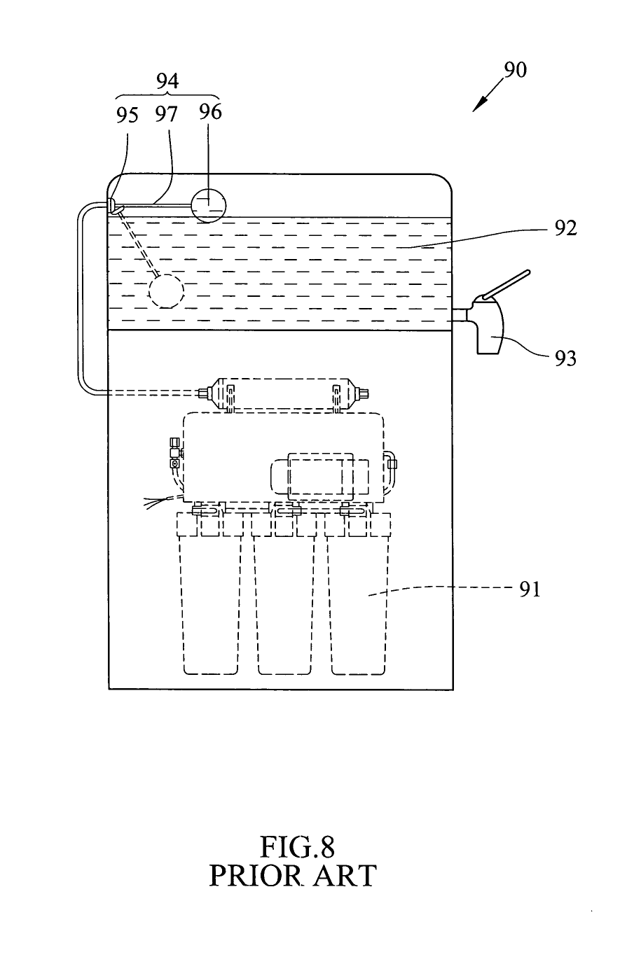

### DETAILED DESCRIPTION OF THE PREFERRED EMBODIMENT

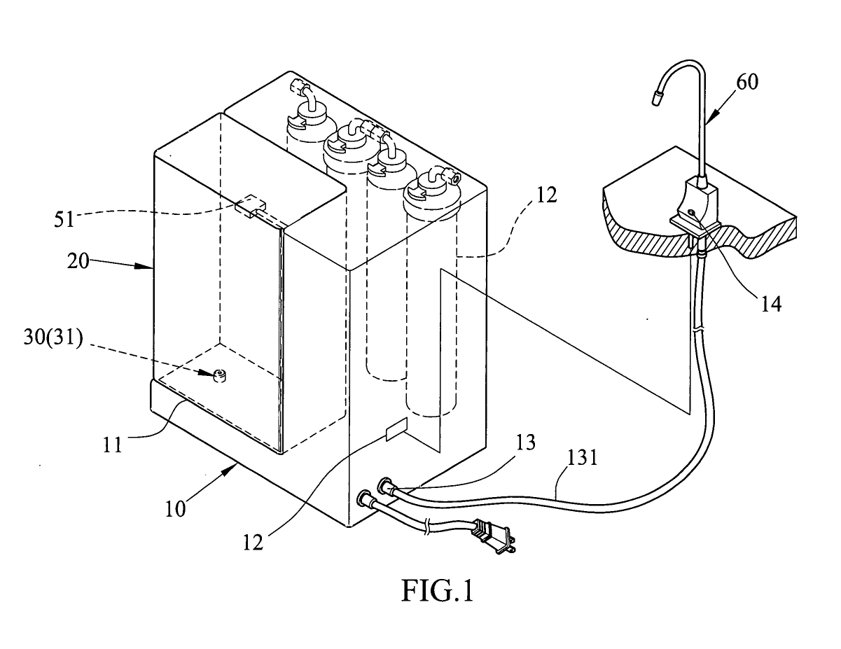

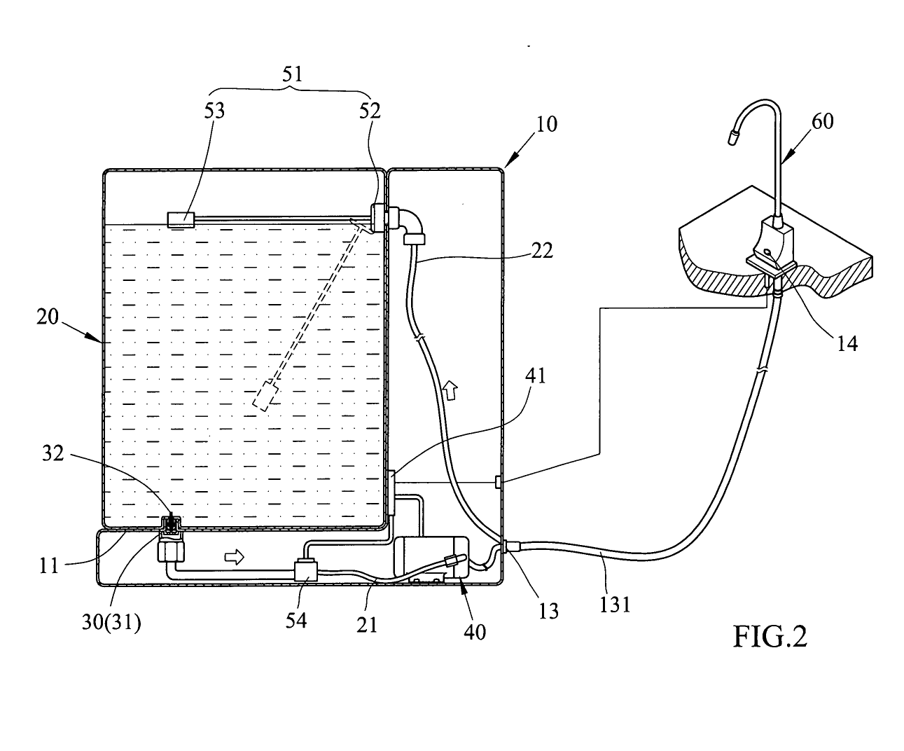

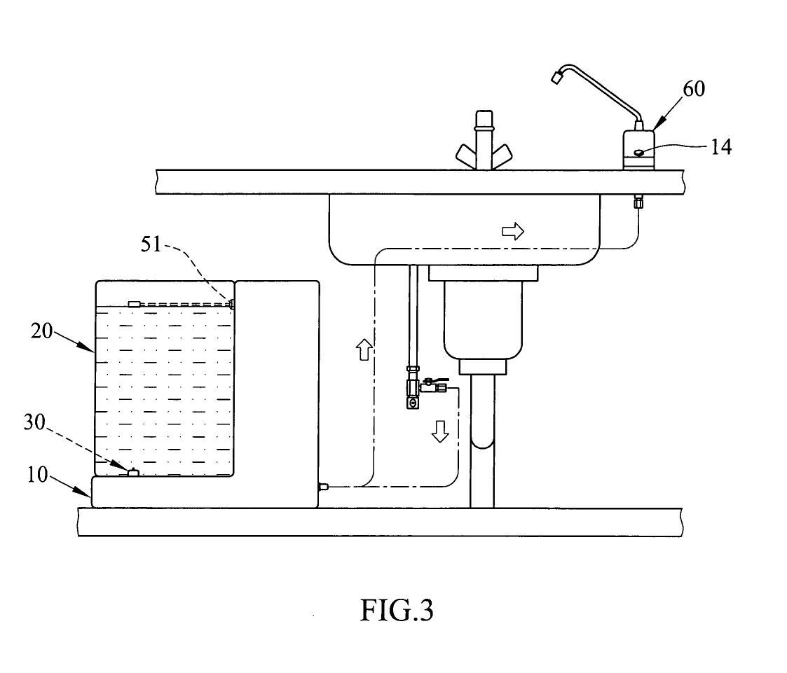

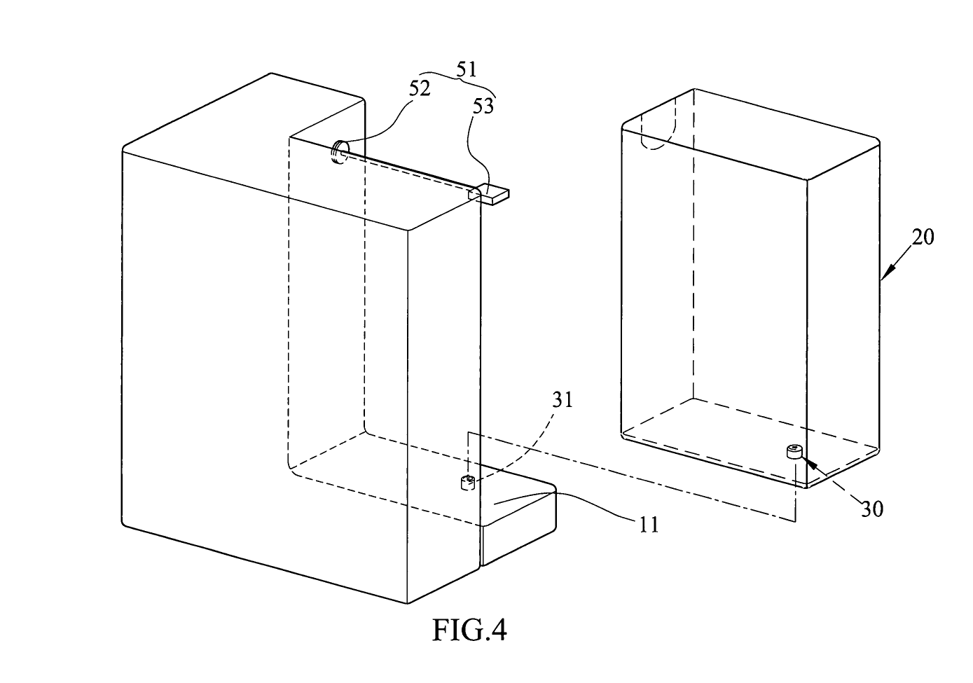

Referring to FIGS. 1 to 4, the water purifying system of the present invention comprises a base 10 having a recess 11 defined in an outside thereof and a storage tank 20 is removably engaged with the recess 11. A purifying device 12 is received in the base 10 and includes a plurality of reverse osmosis tubes so that water is introduced into the reverse osmosis tubes to become purified water. A connection pipe 22 is connected between the storage tank 20 and the purifying device 12. Therefore, the purified water is stored in the storage tank 20. An outlet 13 is defined through a wall of the base 10 and an outlet pipe 21 is connected between the storage tank 20 and the outlet 13. A hose 131 is connected between the outlet 13 and a faucet 60, and a switch 14 is cooperated with the faucet 60.

A through hole 30 is defined through a wall of the base 10 and communicates with the storage tank 20. A one-way valve 31 is engaged with the through hole 30 so that the water in the outlet pipe 21 cannot re-entered into the storage tank 20. A seal device 32 is removably engaged with the through hole 30 such that when the storage tank 20 is removed from the recess 11 to be cleaned up, the seal device 32 seals the storage tank 20. A pumping device 40 is received in the base 10 so as to pump water in the storage tank 20 to the faucet 60 via the outlet 13.

A high level device 51 is received in the storage tank 20 and includes a level detection member 53 and a link 52 which is pivotably connected to a valve on an inside of the storage tank 20. A low level device 54 is connected to the outlet pipe 21 so as to check that there is water in the outlet pipe 21. A control device 41 is connected to the low level device 54 and the pumping device 40. When the level detection member 53 detects that the level is low in the storage tank 20, the level detection member 53 sends a signal to the control device 41 and the control device 41 commands the pumping device 40 to pump purified water into the storage tank 20. When the low level device 54 detects that no water in the outlet pipe 21, the control device 41 cuts off the electric power to the pumping device 40.

When a user pushes the switch 14 cooperated with the faucet 60, the control device 41 receives a signal from the switch 14 so that the pumping device 40 pumps the purified water from the storage tank 20 to the faucet 60.

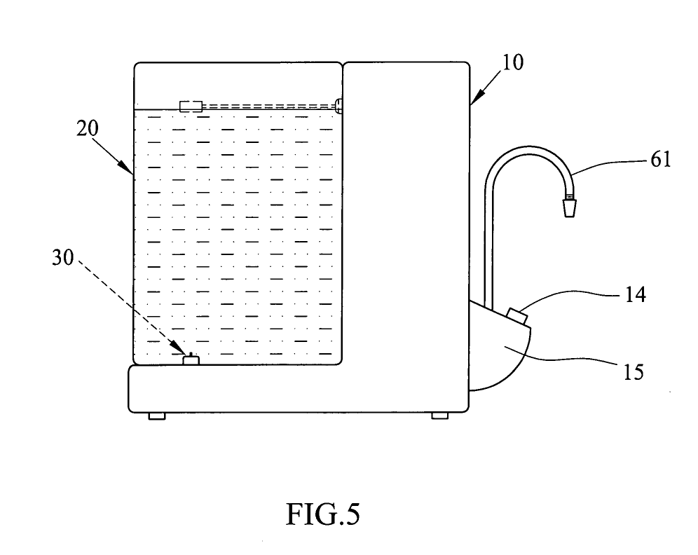

FIG. 5 shows that the faucet 61 together with the switch 14 can directly connected to a protrusion 1 5 which is connected to a side of the base 10.

The water purifying system of the present invention is compact in size and has shorter piping connection. The water purifying system can easily meet different types of needs. The storage tank 20 can be easily removed from the base 10 and cleaned up.

While we have shown and described the embodiment in accordance with the present invention, it should be clear to those skilled in the art that further embodiments may be made without departing from the scope of the present invention.

What is claimed is:

1. A water purifying system comprising:
a base having a recess defined in an outside thereof and an outlet defined through a wall of the base;
a purifying device received in the base, and
a storage tank removably engaged with the recess and connected with the purifying device by a connection hose, an outlet pipe connected between the storage tank and the outlet.

2. The system as claimed in claim 1, wherein a through hole is defined through a wall of the base and communicates with the storage tank, a one-way valve is engaged with the through hole.

3. The system as claimed in claim 2, wherein a seal device is removably engaged with the through hole.

4. The system as claimed in claim 1, wherein a pumping device is received in the base so as to pump water in the storage tank out from the outlet, a high level device is received in the storage tank and a low level device is connected to the outlet pipe, a control device is connected to the low level device and the pumping device.

5. The system as claimed in claim 1, wherein the high level device includes a level detection member and a link which is pivotably connected to a valve on an inside of the storage tank.

6. The system as claimed in claim 1, wherein a hose is connected between the outlet and a faucet, a switch is cooperated with the faucet.
